(19) United States
(12) Patent Application Publication
(10) Pub. No.: US 2026/0257198 A1
(43) Pub. Date: Sep. 3, 2026

(54) POROUS NANOCOMPOSITES OF OXIDISED NANOFIBRILLATED CELLULOSE AND NATURAL RUBBER LATEX COMPRISING ANTIMICROBIAL METAL OXIDES, PRODUCTION PROCESSES AND USES

(71) Applicant: CENTRO NACIONAL DE PESQUISA EM ENERGIA E MATERIAIS, Campinas (BR)

(72) Inventors: Nadia ANDRADE ALEIXO, Campinas (BR); Rubia FIGUEREDO GOUVEIA, Campinas (BR)

(21) Appl. No.: 19/163,666

(22) PCT Filed: Mar. 9, 2024
(86) PCT No.: PCT/BR2024/050084

§ 371 Date: Sep. 9, 2025

(30) Foreign Application Priority Data
Mar. 10, 2023 (BR) 1020230044646

(51) Int. Cl. B01J 20/24; B01J 20/32; B82Y 30/00; B82Y 40/00; C02F 1/28

(52) U.S. Cl. CPC B01J 20/24; B01J 20/3236; C02F 1/288; B01J 2220/4818; B01J 2220/4825; B82Y 30/00; B82Y 40/00; C02F 2303/04

(57) ABSTRACT

This invention describes new porous nanocomposites of oxidized nanofibrillated cellulose and natural rubber latex comprising antimicrobial metal oxides deposited on the surface and interior thereof, production processes therefor, and uses thereof in material and fluid decontamination processes.

### TECHNICAL FIELD OF THE INVENTION

This invention describes new porous nanocomposites comprising antimicrobial metal oxides deposited on its surface (internal and external), as well as a new process for deposition of metal oxides in said porous nanocomposites. Furthermore, this invention pertains to the fields of chemistry, materials engineering, and material and fluid decontamination.

### BACKGROUND OF THE INVENTION

Currently, regulatory bodies such as the United Nations (UN), World Health Organization (WHO), and Centers for Disease Control and Prevention (CDC) have called for the need for accessibility to drinking water. Hospital, industrial, pharmaceutical, domestic, and agricultural waste, even in low concentrations, or even traces of chemical pollutants and microorganisms, may result in the development of organisms potentially resistant to conventional antimicrobial agents. In this context, contaminants of emerging concern (CEC) comprise a broad class of contaminants originating from various anthropogenic or natural sources such as antibiotics, hormones, anti-inflammatories, personal hygiene products, disinfection by-products, microplastics, microorganisms and toxins, among others. Although sewage treatment plants have some strategy for removing these compounds, this does not apply to wastewater treatment plants, in which conventional methods are efficient for removing classic contaminants (organic matter and nutrients) but insufficient for sequestering said CEC, thus promoting infections due to pathogens and resistance genes thereof. Therefore, the development of new technologies for the purpose of removing CEC and genetic materials therefrom is needed, especially if they are produced with environmentally compatible methodologies and are versatile as to several polluting compounds.

Gustafsson et al. (2018) report knowledge of at least 140 waterborne pathogens, which include bacteria, viruses, and protozoa. Ashbolt et al. (2015), on the other hand, suggest that this number is even higher, with around 500 pathogens, according to data obtained by the US Environmental Protection Agency (EPA). Viral inactivation and/or elimination is more difficult when compared to bactericidal effect, therefore, treatments that promote bacterial elimination may not be effective for viral pathogens. Furthermore, standard viral disinfection methods are aimed at non-enveloped viruses, thus excluding the possibility of encompassing enveloped viruses, such as SARS-CoV-2, given the current appeal of the 2019-2020 pandemic caused by said virus. Although the transmissibility of SARS-CoV-2 is related to respiratory droplets, researchers point to the presence of viral RNA in wastewater excreted in feces.

In view of this, porous materials have been considered for the treatment of effluents and aqueous means (lakes, rivers, seas, and wastewater). In this context, in the past 20 years, fibrillated nanocellulose (NFC) and crystalline nanocellulose (CNC) have stood out in the field of new absorbent materials due to low density, high mechanical strength, and flexibility properties thereof, as well as its renewable and biodegradable character. The extraction and comminution of cellulose from biomass makes obtaining a renewable source material on a nanometric scale with exceptional mechanical properties and biocompatibility possible, thus rendering it an excellent alternative for the development of new nanocomposite materials.

The absorption versatility of various pollutants by porous nanocomposites of fibrillated nanocellulose containing natural rubber latex (NFC/NRL) has already been described in patent application BR102021021329-9 and BR102019025637-0, together with their structural resilience in aqueous media and in organic solvents. On the other hand, said porous nanocomposites lack the capacity to retain and/or inactivate microorganisms, such as viruses and/or bacteria. This patent application thus aims to solve such a scientific-technological challenge.

Lorevice et al. (2020) discloses a new nanocomposite material and its main structural features. This material consists of a physical mixture of nanofibrillated cellulose (NFC) and natural rubber latex (NRL), and materials in various concentration ratios between NFC and NRL are disclosed.

BR 10 2021 021329 9, owned by the same applicant as this patent application, describes a new foam comprising oxidized fibrillar structure cellulose (NFCOxi) and high-porosity NRL, containing low density, high adsorption capacity for inorganic compounds (heavy metal precursors), and organic compounds (dyes and detergents). However, a limitation of said patent is the non-adsorption and/or bacteria death, as well as virus adsorption and/or inactivation (biological CECs), given that said foams have no nanoparticle deposition on its surface and interior. Another limitation is the absence of a nanoparticle synthesis process in the material, in addition to the proven antibacterial activity.

The paper “Development of biodegradable semiconducting foam based on micro-fibrillated cellulose/Cu-NPs” (https://doi.org/10.1016/i.ijbiomac.2019.03.156) discloses the production of microfibrillated cellulose foams, in which the phosphoric acid process takes place. However, this substance alters cellulose crystallinity. Furthermore, the nanoparticle synthesis process is complex and uses several reagents: 0.1 M copper (II) sulfate, starch, 0.2 M hydroxylamine hydrochloride (used for water treatment due to its potent oxidation), 1 M sodium hydroxide, a centrifugation step, and includes washing with ethanol. This work further addresses an ex-situ synthesis process, which does not ensure cellulosic material integrity. After incorporating NPs, foams undergo porosity and microstructure changes.

Pulutan et al. (2018) developed polyurethane (PU) foams containing copper particles deposited on its surface and having bactericidal properties. However, the process disclosed in the paper has reaction conditions focused on a more resistant material, and is quite aggressive in maintaining the fiber structure integrity of a more sensitive material such as cellulose. Furthermore, PU is a synthetic material that may have low or no degradability, and most PU foams require additives in their composition to control shape and internal structure. Thus, from what can be inferred from the researched literature, no documents were found anticipating or suggesting the teachings of this invention.

### SUMMARY OF THE INVENTION

This invention thus aims to solve the problems present in the state of the art using a new porous nanocomposite comprising NFCoxy and NRL comprising copper oxide (CuO) particles deposited on its surface and interior that are useful as materials for decontaminating materials and fluids and with excellent antimicrobial activity. Furthermore, a new process for deposition of metal oxide particles with antimicrobial properties in porous nanocomposites comprising NFCoxy and NRL is presented, comprising the following steps:
i. mixing a salt solution from the respective metal with antimicrobial properties with the nanocomposite comprising oxidized nanofibrillated cellulose and natural rubber latex, subjecting the mixture to stirring;
ii. inserting the nanocomposite resulting from step (i) in a basic solution at a temperature between 50° C. and 90° C., subjecting the mixture to stirring;
iii. washing and drying the nanocomposite resulting from step (ii).

These and other objects of the invention will be immediately recognizable to those skilled in the art and descriptions will be provided below in sufficient detail for their reproduction by one skilled in the art.

### BRIEF DESCRIPTION OF THE FIGURES

In order to better define, illustrate, and clarify the content of this patent application, the following Figures are presented:

FIG. 1: Scanning electron microscopy (SEM) of nanocomposite (NFC/NRL) (a) and the CuO structures in NC/CuO-20 (b), NC/CuO-60 (c) and NC/CuO-120 (d).

FIG. 2: Morphological and energy-dispersive X-ray spectroscopy images of porous nanocomposites: NC/CuO-20, NC/CuO-60, and NC/CuO-120.

FIG. 3: X-ray photoelectron spectroscopy of functionalized porous nanocomposites: NC/CuO-20, NC/CuO-60, and NC/CuO-120.

FIG. 4: Wide-scan spectrum (XPS) of the nanocomposite (NFC and NRL) used as reference, i.e., without CuO particle deposition.

FIG. 5: Scanning electron microscopy of porous nanocomposites after bacterial essay. The surface of the NC is shown in brown, while E. coli bacteria adsorbed on the surface of the nanocomposite is shown in red (A). CuO particles adhered to NC/CuO-20 (B) are shown in blue. Color images are composed by superimposing Figures, assigning color scales thereto.

FIG. 6: Original images (without treatment) related to FIG. 5.

FIG. 7: Bacterial cell viability test after contact with porous nanocomposites (NC, Nc-CuO-20, NC/CuO-60, and NC/CuO-120) exemplified in this patent application. Equal letters indicate no significant difference (95% statistical significance), while different letters indicate statistical difference in the variance analysis, which was treated by ANOVA and Tukey's test.

### DETAILED DESCRIPTION OF THE INVENTION

This detailed description of the invention establishes some non-limiting definitions of the main terminologies and technical features used throughout this patent application, as well as providing examples of some of the embodiments of this invention so that it can be reproduced by one skilled in the art.

This invention concerns a porous nanocomposite comprising oxidized nanofibrillated cellulose and natural rubber latex characterized in that it comprises copper oxide particles deposited on its surface and interior.

In one embodiment of this patent application, the cellulose may be from a natural source selected from the group comprising eucalyptus, sugarcane pomace, or mixtures of these two sources.

In one embodiment of this patent application, the concentration of natural rubber latex in dry mass in the cellulose-based nanocomposite is between 5% and 50%, preferably between 10% and 30%.

In one embodiment of this patent application, the NRL dispersion has a pH between 7 and 11.

In one embodiment of this patent application, the nanocomposite comprises an atomic percentage of copper (Cu) deposited on its surface between 1.5% and 10%, preferably between 2% and 6%.

This invention also relates to the process for deposition of metal particles with antimicrobial properties in porous nanocomposites comprising oxidized nanofibrillated cellulose and natural rubber latex, characterized in that it comprises the following steps:
i. mixing a salt solution from the respective metal with antimicrobial properties with the porous nanocomposite comprising oxidized nanofibrillated cellulose and natural rubber latex, subjecting the mixture to stirring;
ii. inserting the nanocomposite resulting from step (i) in a basic solution or reducing agent at a temperature between 50° C. and 90° C., preferably between 60° C. and 80° C., subjecting the mixture to stirring;
iii. washing and drying the nanocomposite resulting from step (ii).

In one embodiment of this patent application, the process for producing the porous nanocomposite containing NFCoxy and NRL comprises mixing a cellulose dispersion with a fibrillar morphology, previously oxidized and homogenized, with a NRL dispersion; stirring the mixture mechanically in order to homogenize it; filling molds with the mixture; freezing the mixture in the mold between −10° C. and −20° C., preferably at −18° C. for a period between 18 and 30 hours; and; freeze-drying the mixture at 10 mBar and a temperature of −45±2° C., for a period between 24 and 48 hours.

The nanocomposite must be mixed with the salt of the respective metal with antimicrobial properties, said salt may be Cu(NO₃)₂, CuSO₄, CuCl₂, Cu(OH)₂, Cu(OAc)₂, or CuCO₃. The basic solution or reducing agent can be selected from NaOH, Acetic Acid, or Mg(OH)₂.

Furthermore, the nanocomposite obtained in step iii may be freeze-dried.

To this end, within the context of this invention, new porous nanocomposites containing NFCoxy and NRL were synthesized and functionalized with CuO particles.

In the context of this invention, the generated product may be applied in bacteria adsorption and elimination, as well as in the inactivation of enveloped viruses, such as SARS-CoV-2 and its genetic material, and may also be applied for material and/or fluid decontamination in wastewater treatment plants, in the production of water and air purification filters and/or coupling in face masks.

### Example 1

### Production of Porous Nanocomposites (Foams) of Nanofibrillated Cellulose and Natural Rubber Latex

The ratios between the nanocomposite base components (NFCoxi and NRL) were previously investigated by the applicant, and based on 3D architecture, morphology, structural resilience, porosity, among other parameters. Therefore, the optimized concentration and ratio chosen to be exemplified in this patent application was 2% in dry mass and a component ratio of 80/20 (NFCoxy/NRL). Nanocomposite production followed the method described by Lorevice et al. (2020) and BR102021021329-9. Porous nanocomposites based on NFCoxy contained 2% dry mass, of which 80% is NFCoxy due to the catalytic action of 2,2,6,6-tetramethylpiperidine 1-oxyl (TEMPO) (NFCoxy) and 20% is NRL. The procedure consists of dispersing the NFCoxi and water mass using Turrax for 5 minutes at approximately 30,000 rpm. The suspension was subjected to high-end ultrasound (40% amplitude) for a further 10 minutes, alternating between two periods for manual homogenization. After adding NRL, the dispersion (NFC and NRL) was mechanically stirred for 30 minutes with a metal rod.

Approximately 1.5 to 2 grams of the suspension were poured into plastic vessels 1.5 cm in diameter and 2.0 cm in height. This geometry can be changed for this process. These vessels containing the nanocomposite suspension (NFC and NRL) were cooled to −18±2° C. (for 24 hours) and then freeze-dried for 48 hours.

### Copper Oxide Particle Deposition

The chemical reduction technique involved metal salt reduction in a solvent and reducing agent. The CuO synthesis methodology herein was designed to take place in the medium containing the NFCoxy and NRL porous nanocomposites and functionalize them with copper oxide particles, said functionalization and process being this invention's key difference when compared to the technologies disclosed prior to the filing of this patent application. In other words, the porous NFCoxy and NRL nanocomposites are used as a 3D template for growing the active CuO particles, producing a material which maintains the initial high porosity feature needed for proper microorganism capture.

The porous NFCoxy nanocomposites containing NRL were inserted into 0.2M copper II nitrate (CuNO₃)₂ solution at room temperature and pressure. Then magnetically stirred at 250 rpm for different periods: 10, 30, and 60 minutes. The porous nanocomposites were subsequently inserted into the sodium hydroxide solution (0.25M NaOH) at 70° C. with stirring at 250 rpm, for the same respective period of time. The nanocomposites were washed by dialysis in deionized water for 7 days to ensure the removal of salts and substances not adhered to the material. Subsequently, the nanocomposites were placed in the freezer for 2 hours and then freeze-dried for 24 hours. The porous NFC nanocomposites containing NRL and functionalized received the following nomenclature: NC/CuO-20, NC/CuO-60, and NC/CuO-120, according to the total synthesis time of 20, 60, and 120 min, respectively. It is worth noting that other salts with similar features such as CuSO₄, CuCl₂, Cu(OH)₂, Cu(OAc)₂, or CuCO₃ may be used as an alternative to copper II nitrate (CuNO₃)₂. Other compounds with similar basic or reducing features, such as Acetic Acid or Mg(OH)₂ may be used as an alternative to NaOH.

### Characterization of NC/CuO

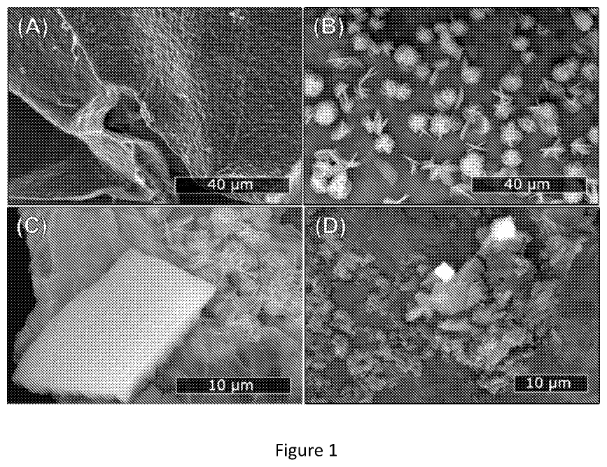

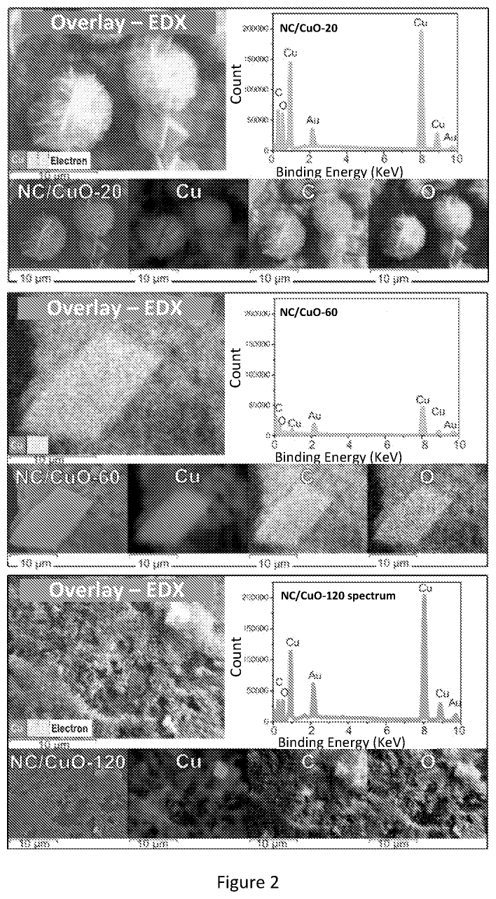

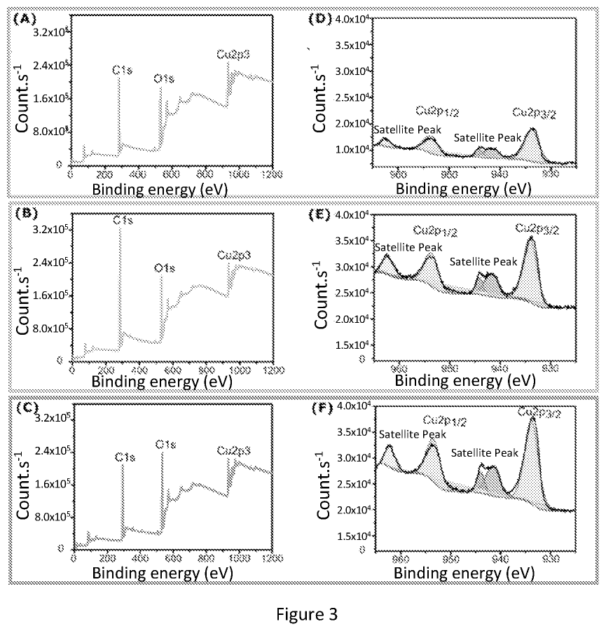

Some characterization techniques were used to verify the CuO nanoparticle deposition in the porous nanocomposites. Scanning electron microscopy (SEM) allowed observing the presence, morphology, and particle sizes of CuO in the porous nanocomposites NC/CuO-20, NC/CuO-60, and NC/CuO-120 (FIG. 1). Energy-dispersive X-ray spectroscopy (EDX) was used to identify the presence of elements formed in the nanocomposites after CuO synthesis (FIG. 2), while X-ray photoelectron spectroscopy (XPS) quantitatively identified Cu (II) presence in the functionalized porous nanocomposites, as well as the binding energy related to each vibration present in the spectrum (Table 1 and FIG. 3).

Regarding the material's morphometry before and after functionalization, calculations were used to evaluate density and apparent porosity, obtaining 31 g/cm³ and 98%, respectively. Density and porosity of the porous nanocomposites were not statistically altered (p<0.05) after the functionalization process with CuO particles. This indicated a highly porous and low-density final material.

The porous nanocomposites were analyzed in one of their cross-sections, by SEM, to characterize its morphology. The variation in synthesis time allowed obtaining different structures on the surface of porous nanocomposites. For NC/CuO-20 (FIG. 1b) the predominant structures were “flower”-like (522±111 nm in diameter) or individual petals (3.1±0.7 μm in diameter). In the case of NC/CuO-60 (FIG. 1c), a rectangular microstructure (8.0±3 μm in diameter) was observed together with spherical CuO clusters and structures similar in morphology and dimension to NC—CuO-20. As for NC/CuO-120 (FIG. 1d), it was possible to visualize structures already observed in both NC/CuO-20 and NC/CuO-60, with a diversity of morphology, including microcubes (more orthorhombic structures) of 1.5±0.4 μm in thickness.

Energy-dispersive X-ray spectroscopy (EDX) is applied to identify element composition. EDX analysis of particle concentration regions indicates the presence of Cu in the composition of functionalized porous nanocomposites. To improve contrast and minimize damage from electron beam radiation to the polymer nanocomposite, the samples were coated with gold (Au), which is present in traces in the samples.

Khan et al. (2015) reports the energy frequencies required to confirm the presence of Cu in CuO nanoparticles, with the peaks at approximately 0.94, 8.04, and 8.94 KeV (FIG. 2) relating to the CuLα, CuKα, and CuKβ energy bands respectively, and are consistent with those reported in the literature. The image called “Overlay—EDX” (FIG. 2) is an assignment of the colors superimposed on the figures: NC/CuO-x, Cu, C, and O, shown below each spectrum.

Surface composition analysis of the NFCoxy and NRL porous nanocomposites, subsequently functionalized with CuO particles, was performed by X-ray photoelectron spectroscopy (XPS) in samples with different synthesis times, 20, 60, and 120 minutes. The experiment was based on the acquisition of high-resolution, broad-energy XPS spectra of copper, carbon (C), and oxygen (O). The software Avantage was used to process data.

NFCoxy and NRL porous nanocomposites show C1s and O1s peaks respectively present at 287 and 534 eV. After functionalization, Cu (II) presence is shown in the broad energy spectrum at 934.1 eV (FIG. 3a-c). High-resolution spectra show Cu valence states with vibrations at 933.7 and 953.8 eV, respectively corresponding to the Cu2p1/2 and Cu2p3/2 binding energies (FIG. 3d-f), typical for the Cu²⁺ character in CuO. Furthermore, the distinction between the oxidation states of Cu occurs by the presence of a Cu2p double satellite peak, centered at 941.8 and 944.4 eV, and single satellite peak at 962.3 eV (FIG. 3d-f). This data confirms the successful preparation of CuO-containing materials. The atomic percentage corresponding to each material is described in detail in Table 1, including carbon, oxygen, and copper.

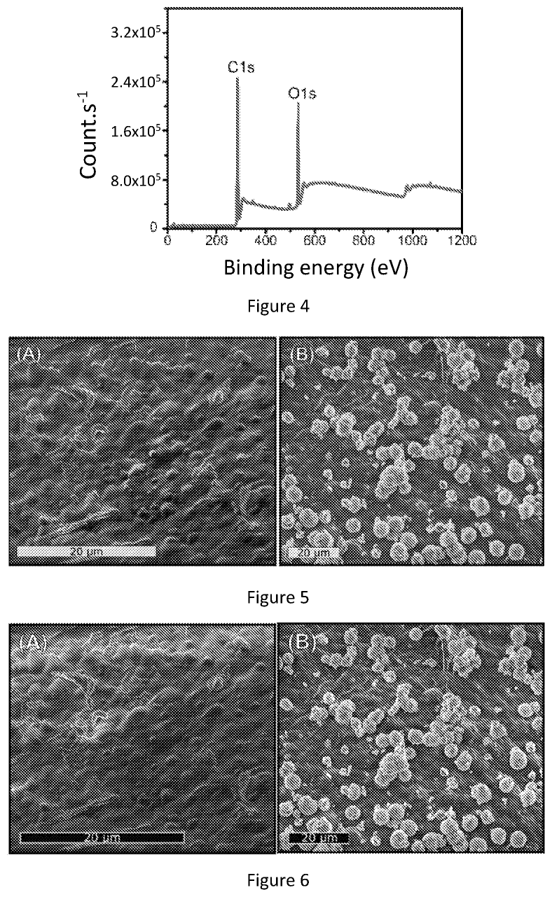

For comparative purposes, FIG. 4 shows the broad energy spectrum of the NFC and NRL nanocomposite used as a reference, i.e., without CuO deposition.

TABLE 1
Surface composition of functionalized porous
nanocomposites by Survey spectra.

| Sample | C [at. %] | O [at. %] | Cu [at. %] |
|---|---|---|---|
| NC | 80.4 ± 1.4 | 19.6 ± 1.4 | — |
| NC/CuO-20 | 64.8 ± 7.3 | 29.7 ± 4.4 | 5.5 ± 2.9 |
| NC/CuO-60 | 75.5 ± 5.5 | 21.9 ± 5.6 | 2.5 ± 0.8 |
| NC/CuO-120 | 68.3 ± 7.6 | 26.2 ± 4.7 | 5.5 ± 2.9 |

### Experimental Test: Bactericidal Activity Against Escherichia coli

The main binding sites on the bacterial surface are the carboxyl and amine groups present in amino acids of cell wall or membrane proteins. Thus, CuO particles can bind thereto more easily, given that Cu²⁺ breaks the membrane and allows the nanoparticles to enter the bacteria. In order to evaluate this hypothesis, a bactericidal activity test against Escherichia coli was performed.

Inoculum preparation: bacterial cells were inoculated into Luria Bertani medium (LB; 1% tryptone; 0.5% yeast extract, and 0.5% NaCl) and kept overnight at 37° C. with stirring at 250 rpm. Pre-inoculums were started with 5% of cells from the saturated culture and maintained at 37° C. with shaking at 250 rpm until the culture reached the exponential growth phase, measured by turbidity through the optical density (OD) at 600 nanometers (OD₆₀₀=0.6).

Antimicrobial activity (more specifically, antibacterial): the porous nanocomposites were deposited in sterile Falcon tubes (50 mL), and subsequently 500 μL of cell suspension (Escherichia coli, E. coli, K-12 MG1655, OD₆₀₀=0.6) were inserted into the surface of the nanocomposite, waiting for total absorption. Then, the nanocomposites, previously swollen with bacterial culture, were incubated in an oven at 37° C. for approximately 4 hours. After the incubation period, said nanocomposites were transferred to essay tubes containing 5 mL of sterile culture medium and incubated overnight in an orbital shaker at 200 rpm, 37° C. To quantify the presence or absence of bacterial growth, OD₆₀₀ of all culture media was measured in a Nanodrop 2000c spectrophotometer (Thermo Scientific) using the software Nanodrop 2000. All microbiological assays were performed in triplicate, using fresh E. coli suspensions.

The images obtained by SEM show microparticles 1.4±0.4 μm in length and 0.47±0.1 μm in diameter (sample number equal to 20) and rod-shaped particles adhered to the surface of the nanocomposite (NFCoxi and NRL), indicating possible Escherichia coli bacteria adsorption in the nanocomposites (FIG. 5, item a). Therefore, the 3D templates' porosity allowed the sequestration of said microorganisms in an aqueous medium.

In the literature, the morphotintural features of Escherichia coli bacteria are described with a pinkish/reddish hue in Gram staining and bacillary morphology, 2 to 6.0 μm in length and 1.1 to 1.2 μm in diameter, and can grow either individually or in pairs. In SEM evaluation, the slight reduction in length and diameter of the supposed bacteria may be related to microorganism dehydration after the experimental essay. In NC/CuO-20 (FIG. 5b), with the characterization method used, no bacteria or their fragments were identified, only particles with typical morphologies for the synthesis time. FIG. 6 shows the original images (without treatment) relative to FIG. 5 (treated).

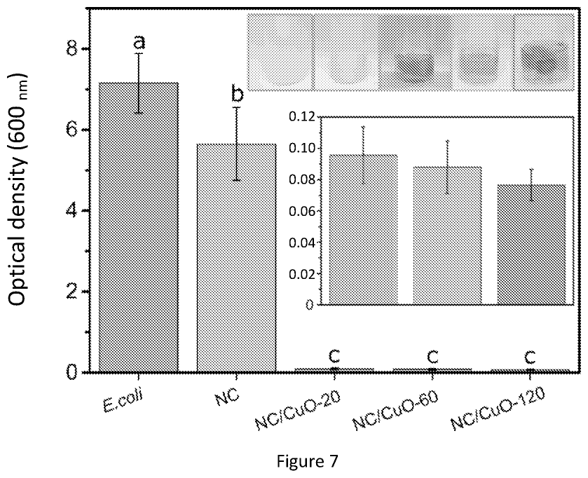

The results of cellular cytotoxicity against E. coli (K-12 MG1655) indicate that bacterial cell viability was reduced after contact with the NFCoxy and NRL nanocomposites functionalized with CuO (FIG. 7). Cell viability percentage was obtained considering the E. coli culture optical density as 100%. Thus, the non-functionalized NFC and NRL nanocomposite allowed the growth of 78.9±0.9% of the cells, while the functionalized porous nanocomposites (NC/CuO) drastically reduced the cell viability: NC/CuO-20 (1.34±0.02), NC/CuO-60 (1.23±0.02), and NC/CuO-120 (1.07±0.01%). These results demonstrated the success and need for functionalization of NFC/NRL nanocomposites with copper (II) oxide particles for antibacterial purposes.

The chemical and structural modifications in the NFCoxy and NRL nanocomposites provided a water-resilient material with greater hydrophobicity and absorptive capacity. Furthermore, this process of cupric oxide (CuO) deposition on a 3D template provides a simple and fast method with diverse morphologies and sizes. Nanocomposite integrity post biological assay may be seen in the highlighted boxes in FIG. 7. Biological investigation has ensured that porous NFCoxy nanocomposites containing NRL have no antibacterial activity in itself but can provide effective growth control against gram-negative bacteria (E. coli K-12 MG1655) when functionalized with copper (II) oxide nanoparticles. Data obtained in the bactericidal assay suggest that nanocomposites are also effective as candidates for inactivating SARS-CoV-2 (due to the structural biological similarity between the outer lipopolysaccharide membrane of gram-negative bacteria and the capsid of enveloped viruses), by means of membrane disruption mechanisms through reactive oxygen species or copper absorption by the lipid membrane, promoting biochemical damage.

The examples disclosed here are intended to merely exemplify some of the many embodiments and uses of this invention, without limiting the interpretation of its scope and breadth as well as possible alternative forms and configurational variations thereof that will be defined from the appended claims.

1. A Porous nanocomposite, comprising:
a porous body having a surface and interior apertures, the body comprising oxidized nanofibrillated cellulose and natural rubber latex; and
copper oxide (CuO) particles deposited on the surface and the interior apertures of the body.

2. The porous nanocomposite, according to claim 1, wherein the atomic percentage of CuO deposited on the surface of the body is between 1.5% and 10%.

3. A process for deposition of metal particles with antimicrobial properties in porous nanocomposites comprising oxidized nanofibrillated cellulose and natural rubber latex, comprising:
i. stirring a salt solution that includes a metal with antimicrobial properties with the porous nanocomposite comprising oxidized nanofibrillated cellulose and natural rubber latex;
ii. inserting the nanocomposite resulting from step (i) in a basic solution or reducing agent at a temperature between 50° C. and 90° C., and subjecting the mixture to stirring; and
iii. washing and drying the nanocomposite resulting from step (ii).

4. The process, according to claim 3, wherein the salt solution comprises at least one of Cu(NO₃)₂, CuSO₄, CuCl₂, Cu(OH)₂, Cu(OAc)₂, and/or CuCO₃.

5. The process, according to claim 3, further comprising the step of freeze-drying the nanocomposite obtained in step (iii).

6. The process, according to claim 3 wherein the temperature in step ii. is between 60° C. and 80° C.

7. The process, according to claim 3, wherein the basic solution or reducing agent comprises at least one of NaOH, Acetic Acid, and/or Mg(OH)₂.

8. A method of decontaminating materials and/or fluids, comprising applying the nanocomposite as defined in claim 1 to the materials and/or fluids.
